(19) United States
(12) Patent Application Publication
(10) Pub. No.: US 2021/0350400 A1
(43) Pub. Date: Nov. 11, 2021

(54) METHOD FOR OPERATING FINANCIAL INVESTMENT PRODUCT AND SYSTEM THEREFOR

(71) Applicant: SHOW BUSINESS INC., Uiwang-si (KR)

(72) Inventor: Minyoung KIM, Uiwang-si (KR)

(21) Appl. No.: 17/277,901

(22) PCT Filed: Sep. 23, 2019
(86) PCT No.: PCT/KR2019/012308

§ 371 Date: Mar. 19, 2021

(30) Foreign Application Priority Data
Sep. 21, 2018 (KR) 10-2018-0113396

(51) Int. Cl. G06Q 30/02; G06Q 40/06

(52) U.S. Cl. CPC G06Q 30/0216; G06Q 30/0235; G06Q 30/0226; G06Q 40/06

(57) ABSTRACT

The invention relates to a system and a method for managing financial investment products mutually beneficial for a company and a customer, and more particularly, to a method comprising of converting sales revenue of merchandise to an investment resource, hosting an investment contest for customers who purchase the merchandise, and having a winner of the contest operate the investment resource, and a system therefor. A method for managing financial investment products according to one embodiment of the present invention, a method comprising opening an investment contest website to hold an investment contest; managing an investment resources; accumulating a special purpose point to a customer through a company server when the customer purchases merchandise and service through a customer terminal on a website of the company server; participating in the contest using the special purpose points by the customer; providing a financial investment management asset to a winner of the contest through the company server; distributing investment profits to the company and the customer if the customer makes profits by managing the financial investment products.

### TECHNICAL FIELD

The invention relates to a system and a method for managing financial investment products mutually beneficial for a company and a customer, and more particularly, to a method comprising of converting sales revenue of merchandise to an investment resource, hosting an investment contest for customers who purchase the merchandise, and having a winner of the investment contest operate the investment resource, and a system therefor.

### BACKGROUND ART

Most companies from a local supermarket to a conglomerate operate reward programs, represented by a mileage program or a loyalty program, for customers in order to strengthen ties with customers and increase their repurchase rate.

However, only few customers effectively use the reward program. Since accumulated reward points can be used only for purchasing merchandise provided by the reward provider, most customers just leave their reward points, failing to find proper uses, or the accumulated reward points automatically expire without customers' knowledge.

According to inspection of government offices in 2017, in case of the three mobile carriers that about 80% of Koreans use, the survey of the reward programs, which provides reward points with 7 years expiration date, revealed that approximately 165.5 billion won was expired since customers did not use on time. In addition, beginning from 2019, the mileage, which has been 10 years since 2008, provided by national airlines will start to automatically expire. Considering that the accumulated mileage provided by the airlines is worth approximately 2.5 trillion won, it is anticipated that the mileage worth 100 million won will automatically expire yearly due to the absence of information and indifference.

Based on the total market scale of reward programs, it is easily estimated that an astronomical amount of money, which is worth the trillions, automatically expire.

The current reward programs seem to be operated for customers; however, in fact, the program operations are unreasonably slanted in favor of the companies, who provide reward points. Specifically, the uses of reward points are limited only for purchasing reward providers' products. Customers also have to accumulate points to a certain amount to use them, which causes inconvenience. In addition, accumulated points expire due to predetermined expiration date.

Meanwhile, regarding the current status of private investors' investment for financial investment products such as stocks and derivative products, when a private investor invests in stocks and derivative products, a direct approach is to open an account in a security company and directly trades a financial investment product, and an indirect approach is to subscribe to funds, and have dividend earning. However, since any of these approaches lead toward either profits or losses like two sides of the same coin, a private investor needs to have competencies including high analytical skills, good judgement, and executive ability to participate in stocks and derivative products.

However, according to Korea Stock Exchange, the number of private investors who participate in the market is over 5 million, and the number of active stock accounts is 23.47 million. Based on this, it is inferred that a significant number of individuals recklessly jump into the stock market, disregarding their investment competencies.

As the problems prove, according to the survey of return on investment (ROI) of entities for past 10 years, which is performed by Daily Joseon and F&Guide, a financial information providing company, the ROI of foreign investors is 78%, the ROI of domestic institutional investors is 9.19%, and the ROI of private investors is −74%. The investment failures of private investors cause decline in income and consumption, and increase of household debts, which accelerate the polarization of wealth. This is a serious social problem that have an adverse influence upon the national economy as well as companies.

Despite of this problem, virtual currency such as bit coin, which is neither key currency nor futures that gives you a commodity when the predetermined future date comes, and has a risk that could be worth zero when there is no trade, is currently a transaction object as well. Considering this situation that lots of people invest in this, desiring profits, social problems caused by investment failures of individuals are more amplified, not lead to break the vicious cycle.

### DETAILED DESCRIPTION OF INVENTION

### Technical Problem

The present invention is devised to solve the problems mentioned above. One object of the invention is to provide a system and a method for managing financial investment products mutually beneficial for a company and a client. According to the present invention, different from a current customer reward program that provides reward points of 0.5˜2% of a product price to a customer who purchases a product to increase repurchase rate, a company provides a customer with Special Purpose Point that can be only used for participating in an investment contest for financial investment products, hosted by the company, and hosts the investment contest. Whenever customers participate in the contest, the company let them pay the contest entry fee with the special purpose point, and converts the collected Special Purpose Point into an investment resource for the investment contest. When the investment contest ends, the company entrusts a winner of the investment contest with investment management of the investment resource. If there are losses occurred in the investment management, the company entirely covers it. If there are profits occurred in the investment management, customers and the company share the profits. This can have an effect on the company to encourage them to consume more and to share the investment profits, and an effect on the customers to receive an investment opportunities with no risk and to have a chance that consumption may lead to another income.

One object of the invention is to provide a system and a method for managing financial investment products providing a special purpose point in a special purpose point account of a customer when the customer purchases merchandise, wherein a use of the special purpose point is limited to participating in an investment contest for financial investment products held by the company.

One object of the invention is to provide a system and a method for managing financial investment products enabling only customers who hold the special purpose point as much as a contest entry fee to participate in the investment contest.

One object of the invention is to provide a system and a method for managing financial investment products deducting some of special purpose points as much as a contest entry fee from the special purpose point account of the customer when the customer participates in the investment contest.

One object of the invention is to provide a system and a method for managing financial investment products converting the deducted points into investment resources for the investment contest that the customer participates in.

One object of the invention is to provide a system and a method for managing financial investment products disclosing the accumulated investment asset on a website and an ordering window in real time when the deducted points is converted into the investment resources to have the contestants to know the records in real time.

One object of the invention is to provide a system and a method for managing financial investment products having the customer have his or her own special purpose point account in order to manage their accumulated money and details of use of the special purpose point.

One object of the invention is to provide a system and a method for managing financial investment products enabling one member to give (transfer) his or her special purpose point to other member to boost the use of the special purpose point.

One object of the invention is to provide a system and a method for managing financial investment products holding the investment contest as a monthly series, from the first day of every month (the next day if the market is closed) to the last day of every month (the day before if the market is closed).

One object of the invention is to provide a system and a method for managing financial investment products proceeding an investment contest only with a single contract that is not affected by the number of contracts to solve the problem that even though contestants do trade with the same price using an initial balance provided by the company, ROI against the initial balance varies depending on the number of contract that each contestant does.

One object of the invention is to provide a system and a method for managing financial investment products quantifying a tick, a minimum measure of a price change, as a scoring unit that is not affected by a price difference between products to solve the problem that ROI varies depending on what product contestants choose to trade due to a price difference between products.

One object of the invention is to provide a system and a method for managing financial investment products dropping out a contestant, whose score reaches to a predetermined minus limit corresponding to a cutoff specified in the application guideline of the investment contest, from the contest to increase contestants' concentration and crisis management ability.

One object of the invention is to provide a system and a method for managing financial investment products minimizing a possibility of a tie ranking among contestants by comparing a score, the number of trades, and an average holding period when determining ranking.

One object of the invention is to provide a system and a method for managing financial investment products determining ranking based on a score as the first criteria, wherein the ranking is determined in order of the score (1 point=1 Tick) from highest points to lowest points.

One object of the invention is to provide a system and a method for managing financial investment products determining ranking based on the number of trades as the second criteria, wherein in case that a tie is occurred among at least two contestants based on the first criteria, the subdivided ranking between contestants in the tie is determined in order of the number of trades from lowest to highest.

One object of the invention is to provide a system and a method for managing financial investment products determining ranking based on average holding period as the third criteria, wherein in case that a tie is occurred among at least two contestants based on the second criteria, the subdivided ranking between contestants in the tie is determined in order of the average stock holding periods from longest to shortest.

One object of the invention is to provide a system and a method for managing financial investment products disclosing contest records including a score, the number of trades, average stock holding periods, and ranking on an ordering window to have contestants to know his or her record in real time.

One object of the invention is to provide a system and a method for managing financial investment products determining the number of winner by a given number corresponding to the quotient of the accumulated investment management asset divided by the investment management asset for each winner (The number of winners=the accumulated investment management asset/the investment management asset for each winner).

One object of the invention is to provide a system and a method for managing financial investment products disclosing a list of winners, contest records, and an investment management asset in a website, and notifying contest results to the winner through emails and texts when the investment contest ends.

One object of the invention is to provide a system and a method for managing financial investment products determining an investment management asset for each winner based on an amount specified in the application guideline of the investment contest and disclosing the information about the investment management asset for each winner on a website and an ordering window to have any contestants to know.

One object of the invention is to provide a system and a method for managing financial investment products enabling the customers to have his or her own contest account integrating contest records from different types of contests in order for the contestants to see their detailed history of contests that they participate in.

One object of the invention is to provide a system and a method for managing financial investment products entrusting a trust account for financial investment products opened in the name of the company to a winner of the contest and having the winner to manage the trust account.

One object of the invention is to provide a system and a method for managing financial investment products directly giving the investment resources to the winner and having them manage the investment resources in case that the contest operation using the trust account under the company's name is not allowed due to legal issues between countries.

One object of the invention is to provide a system and a method for managing financial investment products making an extra contract with the winner to make sure the customer complies with the detailed rules determined in the application guideline of the investment contest.

One object of the invention is to provide a system and a method for managing financial investment products limiting a managing period of the trust account for financial investment products to a certain period specified in the application guideline of the investment contest and ending the management of the trust account when the managing period expires.

One object of the invention is to provide a system and a method for managing financial investment products ending the management of the trust account regardless of the remaining management period if the winner makes losses beyond a certain amount specified in the application guideline of the investment contest.

One object of the invention is to provide a system and a method for managing financial investment products distributing investment profits to the winner and the company according to a distribution ratio specified in the application guideline of the investment contest if the winner makes profits beyond an investment management asset.

One object of the invention is to provide a system and a method for managing financial investment products providing a certain amount of money as an investment management benefit to the winner to relieve mental pressure caused by the investment management and build up a more stable trading environment.

One object of the invention is to provide a system and a method for managing financial investment products extending the investment management period of a winner if the winner makes profits and it is beyond an annual yield specified in the application guideline of the investment contest.

### Technical Solution

To accomplish the above-mentioned object, according to one embodiment of the present invention, a method for managing financial investment products comprising: A method for managing financial investment products, the method comprising:

(a) accumulating, or providing, a special purpose point in a special purpose point account of a customer through a company server when the customer purchases merchandise or uses service through a customer terminal on a website operated by the company server;
(b) participating in the investment contest held in the company server or an investment contest server using the special purpose points, by the customer;
(c) deducting some of special purpose points as much as a contest entry fee from the special purpose point account of the customer who participates in the investment contest, through the company server or the investment contest server;
(d) accumulating investment management resources that are converted from the deducted points, in an investment management resource pool, wherein the investment management resources are for the investment contest that the customer terminal participates in;
(e) determining ranking and a winner of the investment contest when the investment contest ends;
(f) managing a financial investment product account directly by the customer (the winner), wherein the financial investment product account is a trust account for financial investment products that is opened in the name of the company, that has a deposit of an investment management asset, and that is entrusted to the customer;
(g) distributing investment profits to the company and the customer (the winner) if the customer terminal makes the investment profits by managing the financial investment product account.

In a step (a) of accumulating a special purpose point, a use of the special purpose point is limited to participating in an investment contest for financial investment products held in the company server.

In the step (a) of accumulating a special purpose point, accumulated rates of the special purpose point for purchased merchandises are not equal but different depending on the purchased merchandises.

In the step (a) of accumulating a special purpose point, only one special purpose point account is assigned to one customer.

In the step (b) of participating in the investment contest, the company server or the investment contest server announces and informs an application guideline of the investment contest through the website, and

wherein the application guideline includes at least one of a contest information (a contest period and an entry fee), operation rules (contest types, a contest process, a method of ordering and concluding, and a contest cutoff), a method for determining ranking, a method for determining a winner, and a management of investment resources by the winner.

In the step (b) of participating in the investment contest, the investment contest is operated as a monthly series from the beginning of every month to the end of every month.

In the step (b) of participating in the investment contest, the investment contest is proceeded only with a single contract.

In the step (b) of participating in the investment contest, the investment contest is proceeded by quantifying a tick, a minimum measure of a price change, as a scoring unit so that the investment contest is not affected by a price difference between products.

In the step (e) of determining ranking and a winner, the ranking is determined according to priorities of primary factors including a score, the number of trades, an entry point, and an average holding period.

A first criteria to determine the ranking is the score,

a second criteria is the number of trades, and the ranking is determined in order of the number of trades from lowest to highest, and

a third criteria is an average stock holding periods from an entry point to an exit point, and the ranking is determined in order of the average holding period from longest to shortest.

In the step (e) of determining ranking and a winner, the number of winner is determined by a given number corresponding to a quotient of an accumulated investment resources divided by an investment management asset provided to each winner.

In the step (f) of managing a financial investment product account, the investment management asset for each winner is equal regardless of the ranking of the winner.

In the step (f) of managing a financial investment product account, in case that a contest operation using the trust account under the company's name is not allowed due to legal issues between countries, the company server or the investment contest server directly gives investment management resources to the winner, has him open a trust account in the name of the winner, and then makes him manage the investment resources.

In the step (f) of managing a financial investment product account, the investment management asset for each winner is a predetermined amount specified in an application guideline of the investment contest, and a management period of the trust account is a predetermined period specified in the application guideline of the investment contest.

In the step (g) of distributing investment profits, the company server or the investment contest server ends a transaction of the trust account for financial investment products if the winner makes a certain rate of loss against the investment management asset specified in an application guideline of the investment contest.

In the step (g) of distributing investment profits, the company server or the investment contest server has the winner to further manage for a certain period specified in an application guideline of the investment contest if the winner makes profits and reaches to an annual yield specified in the application guideline of the investment contest.

After the step (g) of distributing investment profits, the method further comprises ending a transaction of the trust account for financial investment products by the company server or the investment contest server when a management period of the trust account of the winner, that is specified in an application guideline of the investment contest, expires.

According to one embodiment of the invention, a system for managing financial investment products, the system comprising: a company server that enables a customer terminal to participate in an investment contest for financial investment products by providing a special purpose point to the customer terminal, wherein a use of the special purpose point is limited to participating in the investment contest held by the company when the customer terminal purchases merchandise or uses service through the customer terminal on a website operated by the company; that allows the customer terminal to directly manage a financial investment product account by entrusting a trust account for financial investment products opened in the name of the company and having a deposit of an investment management asset, to the customer terminal; and that distributes investment profits to the company and the customer terminal if the customer terminal makes the investment profits by managing the financial investment product account, and

a customer terminal that receives the special purpose point by purchasing merchandise or using service on the website operated by the company server; that participates in the investment contest; that is entrusted with a trust account for financial investment products from the company server if determined as a winner, wherein the trust account is opened in the name of the company and has a deposit of an investment management asset; that directly manages the financial investment product account; and has a share of investment profits from the company server if there are the investment profits occurred.

A use of the special purpose point is limited to participating in an investment contest for financial investment products held in the company server, and special purpose points are deducted by a contest entry fee when the customer participates in the investment contest.

### Advantageous Effects of Present Invention

According to the solutions described above, the present invention can provide a customer with an investment opportunity through spending in daily life without risk of an investment.

In addition, by providing a customer with an investment opportunity through spending in daily life without risk of an investment, reckless investments in stocks and derivative products, which lead to either profits or losses, disregarding their investment competencies, can be prevented.

Furthermore, encouraging customers to spend on products strengthens competitiveness of the company, and at the same time, product sales are converted to investment resources for the customers, which contributes the customers' income creation and vitalizes a market economy.

Moreover, a company and a customer can establish a mutually beneficial economic community, which realizes profits for each of them, beyond a relation as a supplier and a consumer.

Thus, through an investment contest for financial investment products which is built up both by a company and a customer, anyone can have an opportunity to invest and manage financial investment products. In addition, through this contest, an individual, who has highly competent in investment and management of financial products, can be discovered. Considering that investments in financial investment products are globalized, and wealth is transferred across the border between countries like a soundless war, the present invention can also give tremendous help to the national economy.

### DESCRIPTION OF DRAWINGS

FIG. 1 is a schematic drawing of a system for managing financial investment products according to one embodiment of the present invention.

FIG. 2 is a flow chart of a method for managing financial investment products according to one embodiment of the present invention.

FIG. 3 is a drawing illustrating a schematic process where a customer participates in an investment contest for financial investment products according to one embodiment of the present invention.

FIG. 4 is a flow chart illustrating a method for determining ranking in an investment contest for financial investment products according to one embodiment of the present invention.

FIG. 5 is a flow chart illustrating a method for determining a winner in an investment contest for financial investment products according to one embodiment of the present invention.

FIG. 6 is a drawing illustrating an account of a special purpose point that is provided to a customer according to one embodiment of the present invention.

FIG. 7 is a drawing illustrating an account of an investment contest for financial investment products according to one embodiment of the present invention.

FIG. 8 is a drawing illustrating a list of winners in an investment contest for financial investment products according to one embodiment of the present invention.

FIG. 9 is a drawing illustrating a screen of an investment contest for financial investment products according to one embodiment of the present invention.

FIGS. 10 to 12 are drawings illustrating windows of a trading process provided in an investment contest for financial investment products according to one embodiment of the present invention.

FIG. 13 is a drawing illustrating an application guideline of an investment contest for financial investment products according to one embodiment of the present invention.

### MODE FOR INVENTION

First, terminologies used herein will be defined in order to help understand the present invention.

“Tick” is a minimum measure of the change in the index or the price when trading financial investment products such as stocks, futures, foreign futures, and others.

“Scoring system” is a method for operating a financial investment contest by quantifying a tick, a minimum measure of a price change, as a scoring unit (1 Tick=1 point). In case of a general simulated investment contest, there is a problem that ROI varies depending on what product contestants choose to trade due to a price difference between products. However, by quantifying a tick, a minimum measure of a price change, as a scoring unit, each product is seemingly traded with the same price regardless of actual price of each product, which ensures the fairness of the contest.

“Trade count system” is a method for determining ranking by comparing the numbers of trades, including an entry position and an exit position, between contestants during the contest. It is used to determine ranking when more than two contestants are tied based on the scoring system. By comparing the number of trades between contestants tied each other, a contestant who does less trade is placed in higher ranking.

“Average stock holding period system” is a method for determining ranking by comparing average stock holding periods from an entry position to an exit point between contestants during the contest. It is used to determine ranking when more than two contestants are tied based on the scoring system. By comparing the average stock holding periods between contestants tied each other, a contestant who has a longer average stock holding period is placed in higher ranking.

“Single contract system” is a method of proceeding an investment contest only with a single contract regardless of types of investment contests including a stock investment contest, a domestic future investment contest, and a foreign future investment contest. In case of a general simulated investment contest, there is a problem that even though contestants do trade with the same price, ROI against an initial value varies depending on the number of contract that each contestant does. However, by proceeding an investment contest with a single contract, all the contestant virtually trades under the same conditions, which ensures the fairness of the contest.

“Special purpose point (SP point)” is a point that is provided to a customer who purchases merchandise. While a general point is used to purchase merchandise with discount price, the use of the special purpose point is limited to participating in an investment contest of a financial investment product held in a company server.

Hereinafter, embodiments of the present invention will be described in conjunction with the accompanying drawings.

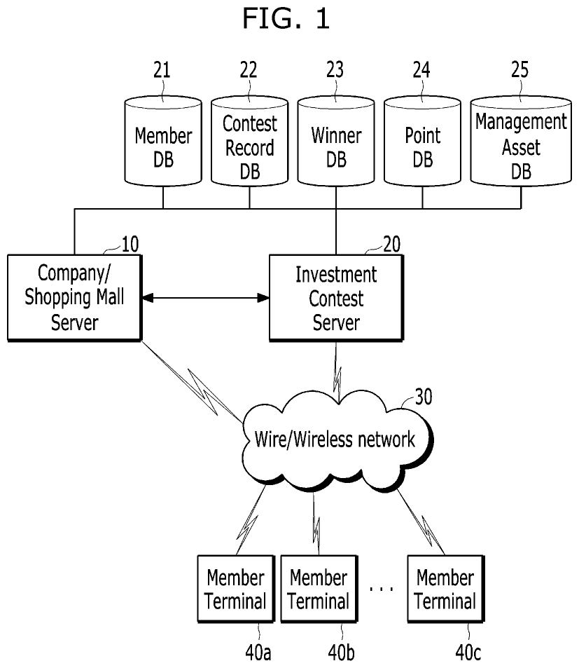

FIG. 1 is a schematic drawing of a system for managing financial investment products according to one embodiment of the present invention.

As illustrated in FIG. 1, in a system for managing financial investment products according to one embodiment of the present invention, a company (or a shopping mall) server 10, or and an investment contest server 20 are connected to customer (or a member) terminals 40a, 40b, . . . , 40n through a wire/wireless network 30.

In this instance, the company server 10 may directly operate and manage the investment contest server 20 or indirectly operate and manage it using a consigned operation and management.

In order to sell merchandise or service and operate an investment contest for financial investment products with a special purpose point, the company server 10 and the investment contest server 20 share information, which is stored in a member DB 21, a contest record DB 22, a winner DB 23, a point DB 24, and a management asset DB 25.

A user's profile information, such as personal information including a phone number and an email address, an ID, and a password, is stored in the member DB 21, by matching identification information of a customer who signs up as a member.

Financial products investment contests are divided into a domestic stock contest, a foreign stock contest, a domestic future contest, and a foreign future contest, and information regarding records of the contests are stored in the contest record DB 22.

Ranking in each investment contest, an ID, a score, a number of trades, an average holding period, and others, are stored in the winner DB 23.

Date and time of trades for each customer (member), a trade type, an accumulation rate of a special purpose point against a merchandise purchase amount, an earned point, a deducted point, an accumulated point, and others are stored in the point DB 24.

Various information regarding a management asset for managing a financial product investment contest, such as an accumulated amount for a management asset, a management asset for a contest winner, and others, are stored in the management asset DB 25.

In addition, the company server 10 and the investment contest server 20 include a member management module, a contest management module, an information providing module, a payment module, and a point management module inside.

The company server 10 provides a special purpose point to a customer when a customer purchases merchandise or uses service on a website operated by the company through the member terminal, which enables the customer to participate in an investment contest for financial investment products held by the company.

Furthermore, the company server 10 determines a winner of the investment contest, and entrust the management of a trust account of financial investment products to the customer (the winner in the contest). In this instance, the trust account is opened in the name of the company, and has a deposit of investment management asset. If the customer, the winner in the contest, makes profits during the management of the trust account for financial investment product, customers and the company share the profits.

The customer terminals 40a, 40b, . . . , 40n are used to purchase merchandise or use service on website operated by the company server 10, and to receive the special purpose point. The customer terminals 40a, 40b, . . . , 40n are also used to participate in the investment contest of financial investment product held by the company server 10 or the investment contest server 20.

In addition, when determined as a winner of the investment contest, the customer terminals 40a, 40b, . . . , 40n are entrusted the management of a trust account for financial investment products, which has a deposit of investment management asset, from the company server 10, and directly manage the trust account for financial investment products. If the customer, the winner in the contest, makes profits during the management of the trust account for financial investment product, customers receive their share of profits through the company server 10.

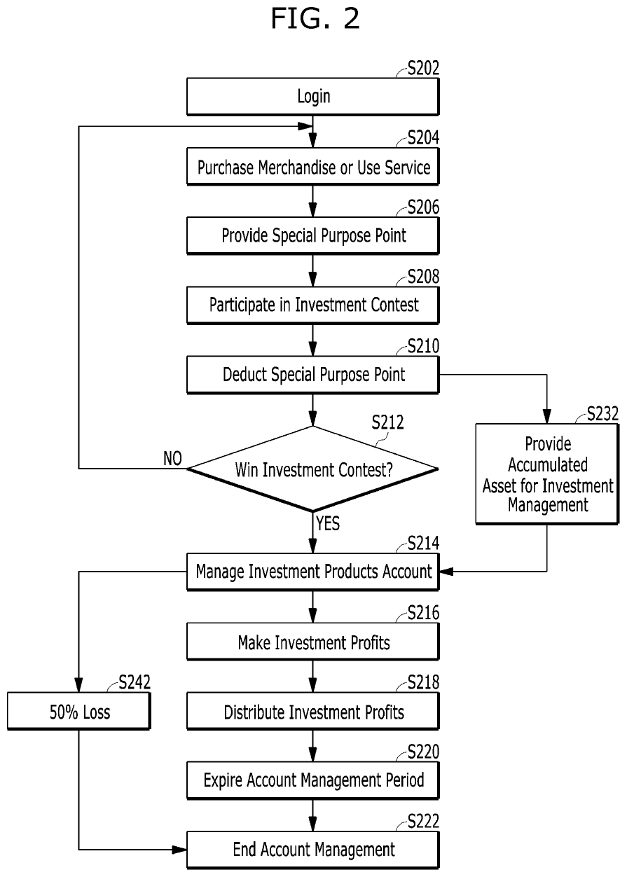

The function or role of the company server 10, the investment contest server 20, and the customer terminals 40a, 40b, . . . , 40n will be described in more detail referring to FIGS. 2 to 5.

FIG. 2 is a flow chart of a method for managing financial investment products according to one embodiment of the present invention.

First, a user accesses to the website operated by the company server 10 through the member terminal, and signs up as a member by entering personal information including an email address and a phone number.

Then, a customer, who is a member, accesses to the website operated by the company server and performs login through the member terminal S202. Then, when the customer purchases merchandise or uses service S204, the company server accumulates, or provides, a special purpose point, which is limited to participating in an investment contest of a financial investment product hosted by a company, in a special purpose point account of the customer. S206.

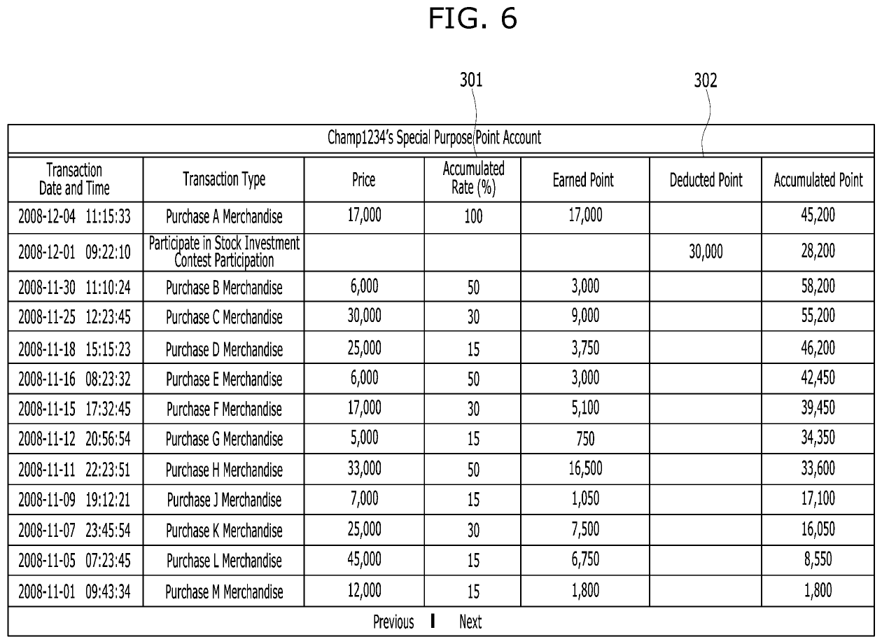

In this instance, as illustrated in FIG. 6, an accumulation rate of the special purpose point (SP point) is not equal, but is applied depending on merchandise.

An individual may have his or her own special purpose point account in order for a customer to manage their accumulated money and details of use of the special purpose point.

Then, when the company holds an investment contest for financial investment products in the company server 10 or the investment contest server 20, the customer participates in the investment contest by paying the entry fee with special purpose points through the member terminal S208.

In this instance, a customer can participate in the investment contest for financial investment products only when he or she has special purpose points enough to pay the entry fee of the investment contest.

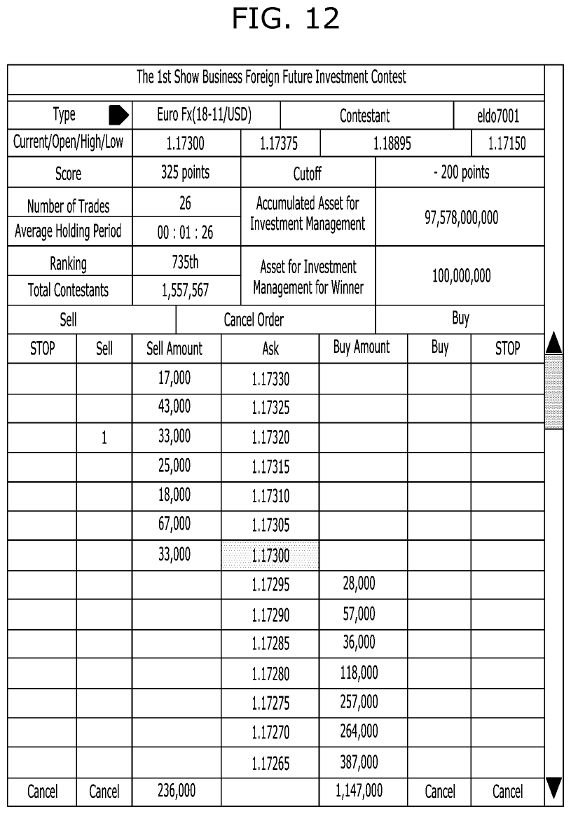

In addition, as illustrated in FIG. 12, the company server or the investment contest server 20 may inform the investment contest by announcing an application guideline of the investment contest through the website operated by the company.

The application guideline of the investment contest includes a contest information (a contest period and an entry fee), operation rules (contest types, a contest process, a method of ordering and concluding, and a contest cutoff), a method for determining ranking, a method for determining a winner, and a management of investment resources by the winner.

In this instance, the contest cutoff is for increasing concentration of contestants. A contestant, whose score reaches to a predetermined minus limit, such as −200 points, may be dropped out from the contest.

The investment contest for financial investment products may be operated monthly, from the beginning of every month (the next day if the market is closed) to the end of every month (the day before if the market is closed).

In addition, the investment contest for financial investment products may be proceeded only with a single contract to solve the problem that ROI against an initial value varies depending on the number of contract that each contestant does.

Furthermore, the investment contest for financial investment products may be proceeded by quantifying a tick, a minimum measure of a price change, as a scoring unit to solve the problem that ROI varies depending on what product contestants choose to trade. Thus, each contestant is not adversely affected by the price difference between products.

Then, the company server or the investment contest server deducts special purpose points as much as the entry fee from the special purpose point account of the customer participating in the investment contest S210.

Referring to FIG. 6, 30,000 points of the special purpose points is deducted as deducted points 302 from the special purpose point for paying the entry fee of the investment contest.

After that, the company server or the investment contest server converts the deducted points to investment management resources of the investment contest, in which the customer participates, and accumulate them in an investment management resource pool, which has been built to collect investment resources for that contest S232.

The accumulated investment asset may be disclosed on a website and an ordering window in real time.

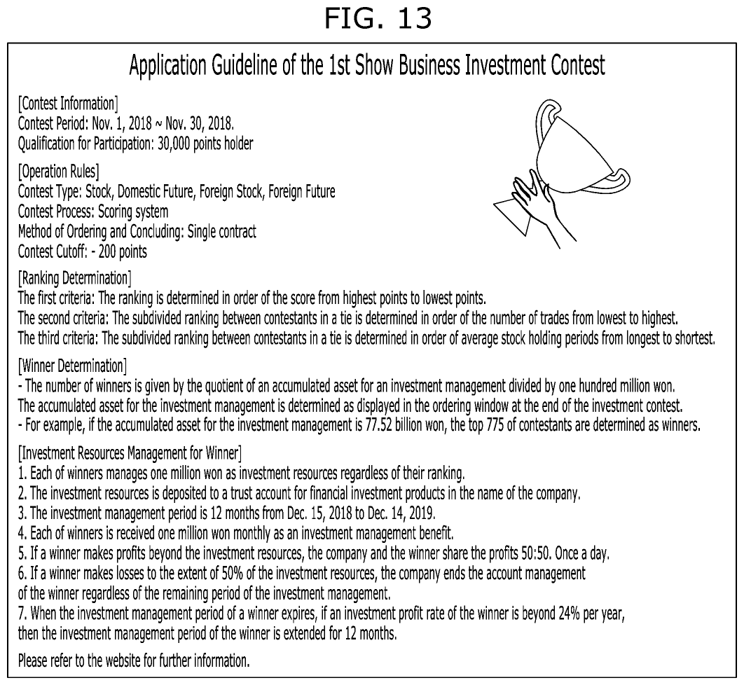

When the investment contest for financial investment products ended, the company server or the investment contest server determines ranking and determines at least one winner. The number of winner is given by the quotient of the accumulated investment asset divided by the managing asset for each winner, which is predetermined in the application guideline of the investment contest in FIG. 13, S212.

In this instance, when determining ranking, a score, the number of trades, an entry point, an average holding period may be primary factors. The ranking may be determined according to priorities of each factor, thereby minimizing a possibility of a tie among contestants.

Thus, as illustrated in FIG. 4, the first criteria to determine ranking is a score. The ranking is determined in order of the score (1 point=1 Tick) from highest points to lowest points S402.

In addition, in case that a tie is occurred among at least two contestants after determining ranking based on the first criteria, the second criteria, the number of trades, may be used to determine subdivided ranking. The subdivided ranking between contestants in the tie is determined in order of the number of trades from lowest to highest S404.

In case that a tie is occurred among at least two contestants even after determining ranking based on the second criteria, the third criteria, the average holding period, may be used to determine subdivided ranking. By comparing average stock holding periods from an entry position to an exit point between contestants in the tie S406, the subdivided ranking between contestants in the tie is determined in order of the average stock holding periods from longest to shortest S408.

The contest records including the score, the number of trades, and average stock holding periods may be disclosed on an ordering window to have the contestants to know his or her record in real time.

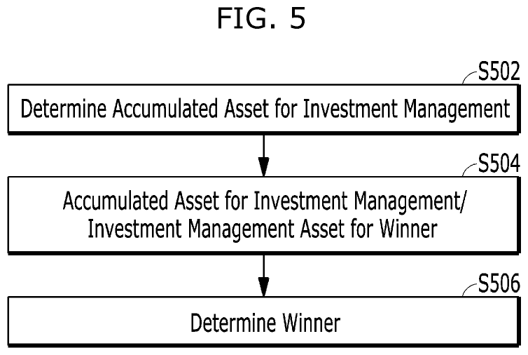

In addition, as illustrated in FIG. 5, the accumulated investment asset is determined S502. The accumulated investment asset is divided by the managing asset for each winner, which is predetermined and specified in the application guideline of the investment contest S504. Then, the number of winner is determined by a given number corresponding to the quotient of the accumulated investment management asset divided by the investment management asset for each winner S506.

When the investment contest ends, a list of winners, the contest records, and the accumulated investment asset may be disclosed on the website to ensure transparency of the contest.

Then, the company server or the investment contest server entrusts the management of a trust account for financial investment products to the customer (the winner in the contest). In this instance, the trust account is opened in the name of the company, and has a deposit of an investment management asset, which is specified in the application guideline of the investment contest. The customer (the winner in the contest) directly manages the trust account for financial investment products S214.

The investment management asset for each winner may be equal regardless of ranking of the winners.

In case that the contest operation using a trust account under the company's name is not allowed due to legal issues between countries, the company directly gives the investment resources to the winner, has them open the trust account in the name of the winner, and then makes them manage the investment resources.

When the investment resources are deposited in the trust account opened in the name of the winner and managed by the winner, the company may make an extra contract with the winner to make sure the customer complies with the detailed rules determined in the application guideline of the investment contest.

The company may provide a certain amount of money specified in the application guideline of the investment contest from the investment management asset provided to the winner.

In addition, the managing period of the trust account for financial investment products provided to the winner may be a certain period specified in the application guideline of the investment contest as the investment management asset provided to the winner.

Furthermore, the company may provide a certain amount of money specified in the application guideline of the investment contest as an investment management benefit to the winner to relieve mental pressure caused by the investment management and build up a more stable trading environment.

Moreover, if the winner makes a certain rate of loss against the investment management asset specified in the application guideline of the investment contest S242, the company may end a transaction of the trust account for financial investment products.

In addition, when the managing period of the trust account for financial investment products specified in the application guideline of the investment contest ends S220, the company may end a transaction of the trust account for financial investment products S222.

Furthermore, if the winner makes profits and reaches to an annual yield specified in the application guideline of the investment contest, the company may have the winner to further manage for a certain period specified in the application guideline of the investment contest.

A customer is entrusted with the trust account for financial investment products in the name of the company. If there are profits occurred in the investment management S216, the company server 10 or the investment contest server 20 distributes the profits to customer and the company S218.

The investment profits may be distributed according to a distribution ratio specified in the application guideline of the investment contest.

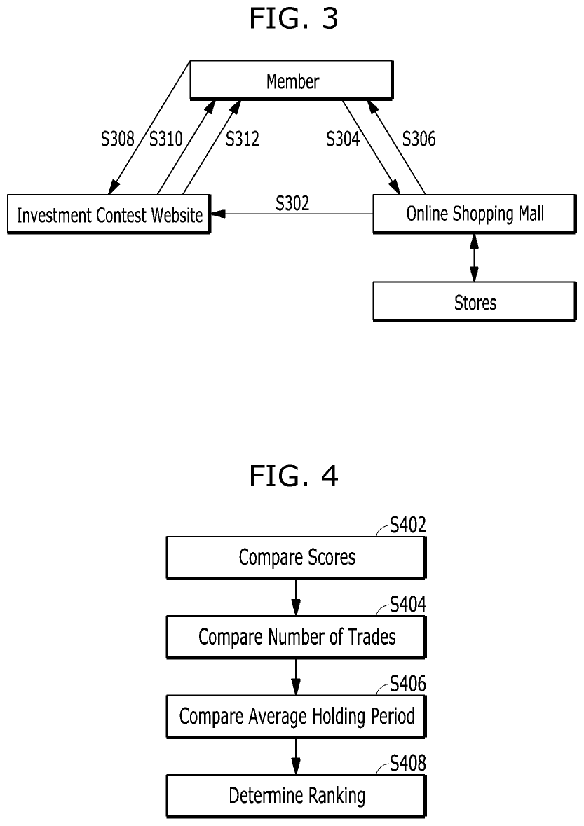

FIG. 3 is a drawing illustrating a schematic process where a customer participates in an investment contest for financial investment products according to one embodiment of the present invention.

As illustrated in FIG. 3, an online shopping mall having multiple stores opens an investment contest website and manage investment resources to hold an investment contest for financial investment products S302.

When a customer purchases merchandise and service through the online shopping mall S304, the online shopping mall accumulates a special purpose point (SP point) to the customer S306.

The customer participates in the investment contest website by using SP points S308, and the company provides a management asset of financial investment products to a winner of contestants S310.

If there are profits occurred in the investment management, customers and the company share the profits S312.

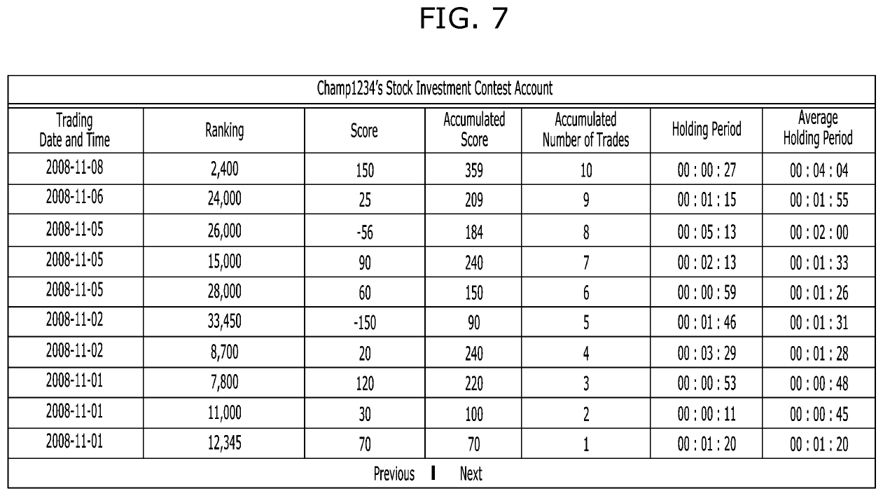

FIG. 7 is a drawing illustrating an investment contest account of financial investment products according to one embodiment of the present invention.

As illustrated in FIG. 7, the investment contest account includes date and time, ranking, a score, an accumulated score, the accumulated number of trades, a holding period, and an average holding period

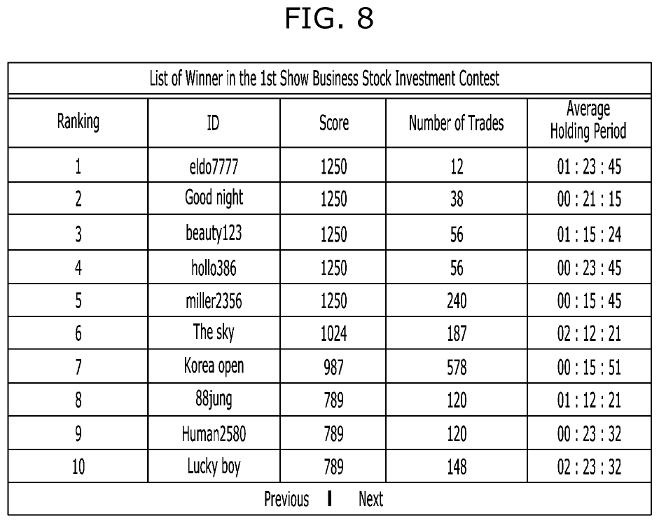

FIG. 8 is a drawing illustrating a list of winners in an investment contest for financial investment products according to one embodiment of the present invention.

As illustrated in FIG. 8, the list of winners includes ranking, an ID, a score, the number of trades, and an average holding period.

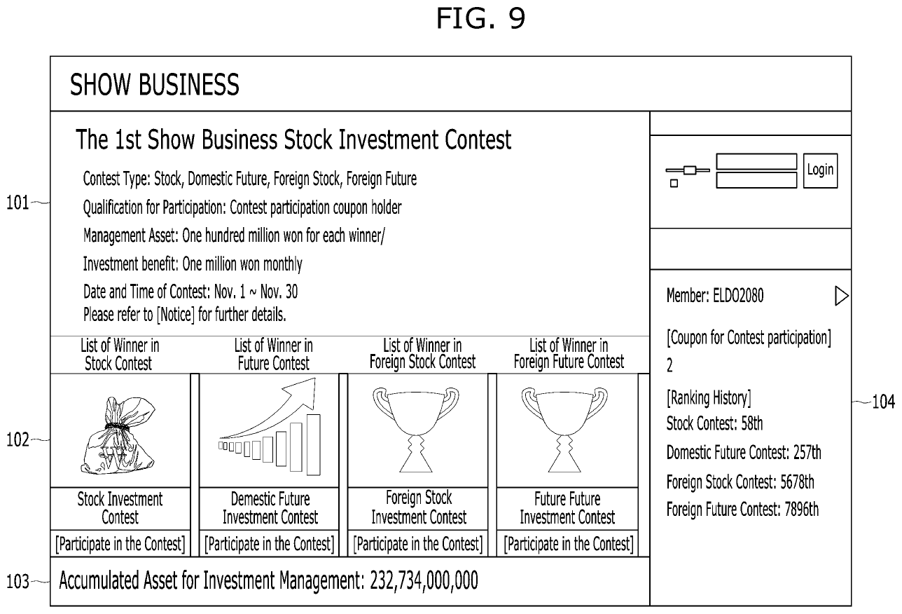

FIG. 9 is a drawing illustrating a screen of an investment contest for financial investment products according to one embodiment of the present invention.

As illustrated in FIG. 9, the screen of the investment contest website displays information of an investment contest 101, a banner window for participating in the investment contest 102, investment management resources disclosed in real time 103, and ranking information.

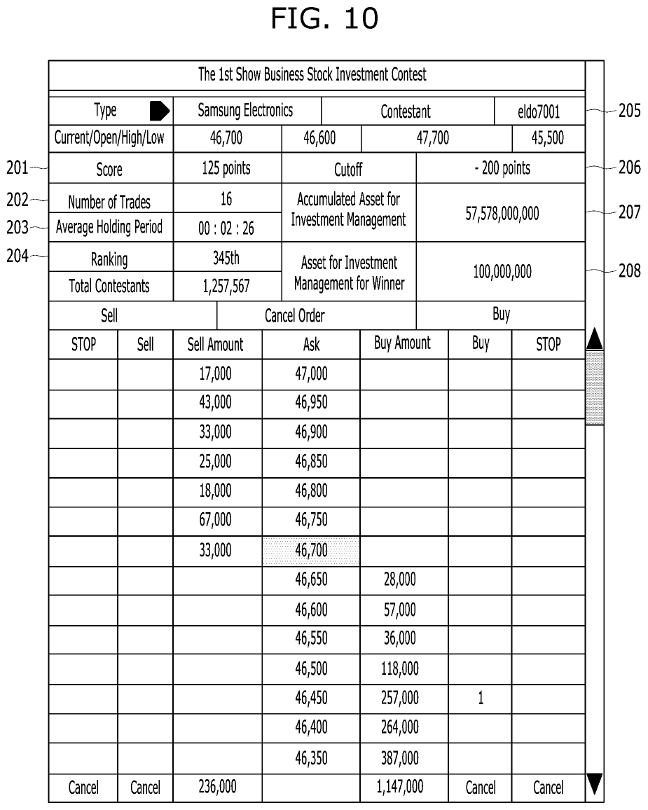

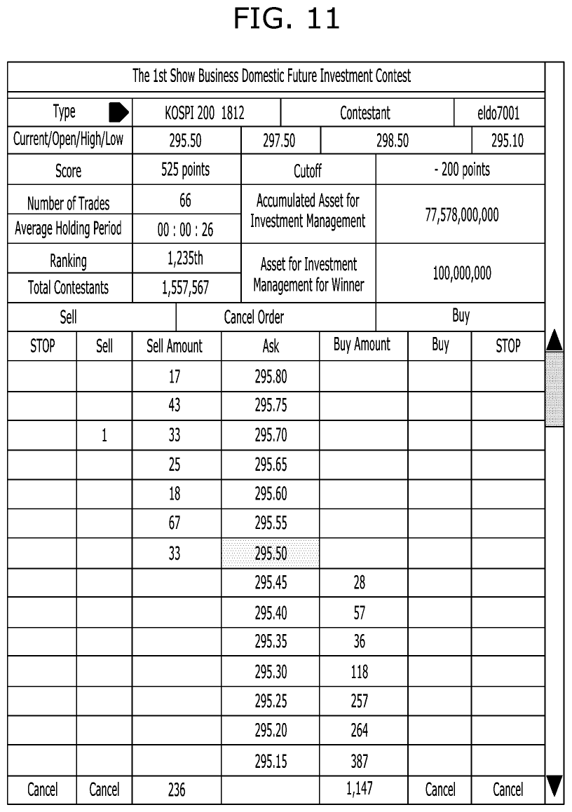

FIGS. 10 to 12 are drawings illustrating windows of a trading process provided in an investment contest for financial investment products according to one embodiment of the present invention.

As illustrated in FIGS. 10 to 12, a contest record of the first place winner 201, a window of a trading process displays a contest record of the second place winner 202, a contest record of the third place winner 203, current ranking 204, contestant IDs 205, a cutoff score 206, an accumulated investment asset 207, and an investment management asset for a winner 208.

1. A method for managing financial investment products, the method comprising:
(a) accumulating a special purpose point in a special purpose point account of a customer through a company server when the customer purchases merchandise or uses service through a customer terminal on a website operated by the company server, wherein a use of the special purpose point is limited to participating in an investment contest for financial investment products held in the company server;
(b) participating in the investment contest held in the company server or an investment contest server using the special purpose points, through the customer terminal;
(c) deducting some of special purpose points as much as a contest entry fee from the special purpose point account of the customer who participates in the investment contest, through the company server or the investment contest server;
(d) accumulating investment management resources that are converted from the deducted points, in an investment management resource pool, through the company server or the investment contest server, wherein the investment management resources are for the investment contest that the customer terminal participates in;
(e) determining ranking and a winner of the investment contest when the investment contest ends, through the company server or the investment contest server;
(f) managing a financial investment product account directly through the customer terminal, wherein the financial investment product account is a trust account for financial investment products that is opened in the name of the company, that has a deposit of an investment management asset, and that is entrusted to the customer terminal through the company server or the investment contest server;
(g) distributing investment profits to the company server and the customer terminal through the company server or the investment contest server if the customer terminal makes the investment profits by managing the financial investment product account, and
wherein in the step (b) of participating in the investment contest, the investment contest is proceeded only with a single contract.

2. The method according to claim 1, wherein in the step (a) of accumulating a special purpose point, accumulated rates of the special purpose point for purchased merchandises are not equal but different depending on the purchased merchandises.

3. The method according to claim 1, wherein in the step (a) of accumulating a special purpose point, only one special purpose point account is assigned to one customer.

4. The method according to claim 1, wherein in the step (b) of participating in the investment contest, the company server or the investment contest server announces and informs an application guideline of the investment contest through the website, and
wherein the application guideline includes at least one of a contest information, operation rules, a method for determining ranking, a method for determining a winner, and a method for managing investment resources for the winner.

5. The method according to claim 1, wherein in the step (b) of participating in the investment contest, the investment contest is operated as a monthly series from the beginning of every month to the end of every month.

6. A method for managing financial investment products, the method comprising:
(a) accumulating a special purpose point in a special purpose point account of a customer through a company server when the customer purchases merchandise or uses service through a customer terminal on a website operated by the company server, wherein a use of the special purpose point is limited to participating in an investment contest for financial investment products held in the company server;
(b) participating in the investment contest held in the company server or an investment contest server using the special purpose points, through the customer terminal;
(c) deducting some of special purpose points as much as a contest entry fee from the special purpose point account of the customer who participates in the investment contest, through the company server or the investment contest server;
(d) accumulating investment resources that are converted from the deducted points, in an investment management resource pool, through the company server or the investment contest server, wherein the investment management resources are for the investment contest that the customer terminal participates in;
(e) determining ranking and a winner of the investment contest when the investment contest ends, through the company server or the investment contest server;
(f) managing a financial investment product account directly through the customer terminal, wherein the financial investment product account is a trust account for financial investment products, that is opened in the name of the company, has a deposit of an investment management asset, and is entrusted to the customer terminal through the company server or the investment contest server, and
(g) distributing investment profits to the company server and the customer terminal through the company server or the investment contest server if the customer terminal makes the investment profits by managing the financial investment product account;
wherein in the step (b) of participating in the investment contest, the investment contest is proceeded by quantifying a tick, a minimum measure of a price change, as a scoring unit so that the investment contest is not affected by a price difference between merchandises.

7. A method for managing financial investment products, the method comprising:
(a) accumulating a special purpose point in a special purpose point account of a customer through a company server when the customer purchases merchandise or uses service through a customer terminal on a website operated by the company server, wherein a use of the special purpose point is limited to participating in an investment contest for financial investment products held in the company server;
(b) participating in the investment contest held in the company server or an investment contest server using the special purpose points, through the customer terminal;
(c) deducting some of special purpose points as much as a contest entry fee from the special purpose point account of the customer who participates in the investment contest, through the company server or the investment contest server;
(d) accumulating investment management resources that are converted from the deducted points, in an investment management resource pool, through the company server or the investment contest server, wherein the investment management resources are for the investment contest that the customer terminal participates in;
(e) determining ranking and a winner of the investment contest when the investment contest ends, through the company server or the investment contest server;
(f) managing a financial investment product account directly through the customer terminal, wherein the financial investment product account is a trust account for financial investment products, that is opened in the name of the company, has a deposit of an investment management asset, and is entrusted to the customer terminal through the company server or the investment contest server, and
(g) distributing investment profits to the company server and the customer terminal through the company server or the investment contest server if the customer terminal makes the investment profits by managing the financial investment product account;
wherein in the step (e) of determining ranking and a winner, the ranking is determined according to priorities of primary factors including a score, the number of trades, an entry point, and an average holding period.

8. The method according to claim 7, wherein a first criteria to determine the ranking is the score,
wherein a second criteria is the number of trades, and the ranking is determined in order of the number of trades from lowest to highest,
wherein a third criteria is an average stock holding periods from an entry point to an exit point, and the ranking is determined in order of the average holding period from longest to shortest.

9. The method according to claim 1, wherein in the step (e) of determining ranking and a winner, the number of winner is determined by a given number corresponding to a quotient of an accumulated investment resources divided by an investment management asset provided to each winner.

10. The method according to claim 1, wherein in the step (f) of managing a financial investment product account, the investment management asset for each winner is equal regardless of the ranking of the winner.

11. The method according to claim 1, wherein in the step (f) of managing a financial investment product account, in case that a contest operation using the trust account under the company's name is not allowed due to legal issues between countries, the company server or the investment contest server directly gives investment management resources to the winner, has him open a trust account in the name of the winner, and then makes him manage the investment resources.

12. The method according to claim 1, wherein in the step (f) of managing a financial investment product account, the investment management asset for each winner is a predetermined amount specified in an application guideline of the investment contest, and a management period of the trust account is a predetermined period specified in the application guideline of the investment contest.

13. The method according to claim 1, wherein in the step (g) of distributing investment profits, the company server or the investment contest server ends a transaction of the trust account for financial investment products if the winner makes a certain rate of loss against the investment management asset specified in an application guideline of the investment contest.

14. The method according to claim 1, wherein in the step (g) of distributing investment profits, the company server or the investment contest server has the winner to further manage for a certain period specified in an application guideline of the investment contest if the winner makes profits and reaches to an annual yield specified in the application guideline of the investment contest.

15. The method according to claim 1, after the step (g) of distributing investment profits, the method further comprises ending a transaction of the trust account for financial investment products by the company server or the investment contest server when a management period of the trust account of the winner, that is specified in an application guideline of the investment contest, expires.

16. A system for managing financial investment products, the system comprising:
a company server that enables a customer terminal to participate in an investment contest for financial investment products by providing a special purpose point to the customer terminal, wherein a use of the special purpose point is limited to participating in the investment contest held by the company when the customer terminal purchases merchandise or uses service through the customer terminal on a website operated by the company; that allows the customer terminal to directly manage a financial investment product account by entrusting a trust account for financial investment products opened in the name of the company and having a deposit of an investment management asset, to the customer terminal; and that distributes investment profits to the company and the customer terminal if the customer terminal makes the investment profits by managing the financial investment product account, and
a customer terminal that receives the special purpose point by purchasing merchandise or using service on the website operated by the company server; that participates in the investment contest; that is entrusted with a trust account for financial investment products from the company server if determined as a winner, wherein the trust account is opened in the name of the company and has a deposit of an investment management asset; that directly manages the financial investment product account; and has a share of investment profits from the company server if there are the investment profits occurred,
wherein the company server proceeds the investment contest only with a single contract.
